(19) United States
(12) Patent Application Publication
(10) Pub. No.: US 2009/0248997 A1
(43) Pub. Date: Oct. 1, 2009

(54) De-Interleaving using minimal memory

(75) Inventor: Moshe Ben-Ari, Givataim (IL)

Correspondence Address: MARTIN D. MOYNIHAN d/b/a PRTSI, INC., P.O. BOX 16446, ARLINGTON, VA, 22215, US

(73) Assignee: Horizon Semiconductors Ltd., Herzlia (IL)

(21) Appl. No.: 12/076,934

(22) Filed: Mar. 25, 2008

(51) Int. Cl. G06F 12/00

(52) U.S. Cl. 711/157; 711/E12.001

(57) ABSTRACT

A de-interleaver for receiving data blocks including data units in an interleaved order, each data unit having a de-interleaved location within the data block, placing the data units in a memory buffer, and outputting the data units in a de-interleaved order from the memory buffer, the de-interleaver including an output unit configured to output a data unit from a location in the memory buffer of a next data unit in de-interleaved order, thereby to provide the data block in de-interleaved order, and an input unit configured with the output unit to input an incoming data unit, the incoming data unit being in the interleaved order, into the location in the memory buffer vacated by the next, in de-interleaved order, data unit being output. Related apparatus and methods are also described.

### FIELD AND BACKGROUND OF THE INVENTION

The present invention, in some embodiments thereof, relates to an architecture of a de-interleaver and to a method of de-interleaving and, more particularly, but not exclusively, to an architecture of a de-interleaver and to a method for de-interleaving ISDB-S (Integrated Services Digital Broadcasting for Satellite) super frame.

An example of de-interleaving interleaved data used herein is de-interleaving a transport stream containing data according to the Japanese ISDB-S (Integrated Services Digital Broadcasting for Satellite) standard. The example is not intended to be limiting, but to provide one real world example. Persons skilled in the art can apply suitable changes to other data de-interleaving cases.

The ISDB-S transport stream contains super frames, which are blocks of data containing 8 frames of data. Each frame of data contains up to 48 slots of data, and each slot of data comprises 203 bytes of data.

Reference is now made to FIG. 1, which is a simplified illustration of the structure of an Integrated Services Digital Broadcasting for Satellite (ISDB-S) super frame 100, as is known in the art.

The ISDB-S super frame 100 contains eight frames 105. Each of the frames 105 contains up to 48 slots 110. Each slot 110 contains 203 bytes. The number of slots 110 per frame 105 is fixed within the super frame 100. The number of slots 110 per frame 105 can be different in different super frames 100. The number of slots 110 per frame 105 may be extracted from metadata accompanying the super frame 100 which precedes the super frame described by the metadata. The above-mentioned metadata is comprised in TMCC (Transmission and Multiplexing Configuration Control) data broadcast as part of the ISDB-S protocol.

It is to be appreciated that because the number of slots per frame is not fixed, except within a super frame, the amount of data in a frame and the amount of data in a super frame are not fixed relative to other super frames in a same ISDB-S broadcast. The physical size of a frame/super frame, that is—the number of symbols per frame/super frame—is fixed.

It is to be appreciated that a maximum size of a frame and a maximum size of a super frame can be known, when the maximum number of slots per frame is known.

An ISDB-S interleaver (not shown) interleaves the data of the super frame 100 along the eight frames. The data is interleaved within each and every slot 105. An arrow 115 indicates a direction of interleaving, being between frames 105 within each slot 110. The data is interleaved at a byte level, that is—bits within a byte are not interleaved.

Video, audio and ancillary data of a signal encapsulated into an MPEG-2 transport stream, according to the Japanese ISDB-S standard, runs through a block interleaver module, after being RS (Reed—Solomon) encoded as a part of a FEC (Forward Error Correction) scheme.

In order to aid understanding what a de-interleaver does, a typical interleaving process is first described.

Reference is now made to FIG. 2A, which is a simplified illustration of a method of interleaving data of eight same numbered slots of eight frames in a super frame according to the ISDB-S standard, as is known in the art.

A super frame of data, such as the super frame 100 of FIG. 1, is written into the interleaver. The data is written frame by frame, slot by slot, in order, into an area of memory 202. Data from a group of an n-th one of the slots from all frames F0 . . . F7, Sn 205, is depicted in FIG. 2A. The data of Sn 205 is in order of the frames 105 (FIG. 1), from F0/Sn to F7/Sn. The direction of writing 210 the data of the slot Sn 205 into the area of memory 202 is depicted as left-to-right.

After all 8 frames F0-F7 of slot Sn have been written in the area of memory 202, the data of the 8 frames of the slot Sn is read from the area of memory 202, in a reading direction 215 from top to bottom.

The reading is performed one byte at a time, in an order from the first frame to the last, producing data in the order shown below the area of memory 202. An amount of data equal to 8 interleaved slots of data 220, of an n-th one of the slots Sn from 8 different frames F0-F7, is depicted in the same order as read, that is F0/Sn/B0, F1/Sn/B0, . . . F7/Sn/B0, F0/Sn/B1, F1/Sn/B1, . . . F6/Sn/202, F7/Sn/B202. It is noted that the data is not read continuously in the above-described order. The first 203 bytes of the interleaved data of slot Sn is read, then 203 bytes of interleaved slot Sn+1 (not shown), thus reading 203 bytes from each slot in order. After reading the first 203 bytes of each slot, a further round of reading the next 203 bytes of slot Sn and the other slots is performed, and so on. The interleaved order is additionally described below with reference to FIG. 2B.

Reference is now made to FIG. 2B, which is a simplified illustration of interleaving in a super frame according to the ISDB-S standard, as is known in the art. The illustration of FIG. 2B is taken from a specification for a generic satellite ISDB-S transmission system, depicting on the left an original super frame, and on the right an interleaved super frame. In the illustration of FIG. 2B, the bytes are named, for example, A1,1, where “A” stands for a first modulation scheme, and “1,1” stands for frame #1, byte #1.

It is noted that the notation of the above-mentioned ISDB-S standard references frames, slots, and bytes, starting from reference number 1. The present specification and claims, unless stated otherwise as in the case of the above-mentioned ISDB-S standard and of FIG. 2B, references frames, slots, and bytes starting from reference number 0.

Interleaving is performed between frames among data in the same rows (slots). Thus, ISDB-S enables having more than one modulation scheme, and does not interleave data between slots of different modulation schemes.

One method of de-interleaving can be to write a first super frame into a first area in memory, then, while a second super frame is being written into a second area in memory, to read data in a de-interleaved order from the first area in memory. The reading or writing function of the first and the second areas in memory is switched every other super frame. This method enables using a fixed reading order for each super frame and a fixed writing order for each super frame.

Reference is now made to FIG. 3, which is a simplified functional block diagram of a de-interleaver 300 with two memory areas, each sufficient for a super frame. The de-interleaver 300 includes a first memory area A 301 and a second memory area B 302, each of the memory areas 301 302 of a size sufficient to contain at least one maximum-sized super frame of data.

While interleaved data is being input 305 and written 307 into the first memory area A 301 of the de-interleaver 300, de-interleaved data is being read 308 from the second memory area B 302 and output 306 from of the de-interleaver 300. Such an implementation of a de-interleaver is termed a double buffer implementation.

After writing 307 a first super frame's worth of data into the first memory area A 301, and at the same time reading a previous super frame's worth of data from the second memory area B 302, the de-interleaver 300 switches the roles of the two memory areas 301 302, writing a second super frame's worth of data into the second memory area B 302, and at the same time reading the first super frame's worth of data from the first memory area A 301. After every super frame, the de-interleaver 300 switches the roles of the memory areas 301 302.

It is to be appreciated that in case of an ISDB-S de-interleaver, one block of memory sufficient for a maximum sized super frame is approximately 609 Kbits, and two blocks are approximately 1218 Kbits.

In order for a de-interleaver to output data of a super frame in de-interleaved order, it is necessary for the de-interleaver to receive the data. In order to output a first slot of a first de-interleaved frame in the super frame, it may be necessary to wait until receiving the last interleaved frame in the super frame, because bytes from the first slot of the first de-interleaved frame may be present in the last interleaved frame.

A first byte of a super frame entering the de-interleaver optionally has to remain in the de-interleaver until all or most of the super frame has entered before being output. Thus the next super frame is likely to already be arriving before the previous super frame output can be completed. The buffer therefore needs room for both super frames, hence the term double buffer implementation.

Additional background art includes U.S. Pat. No. 6,714,606 to Qian et al, which describes an apparatus comprising a memory, a write pointer, a read pointer and a control circuit. The memory may have a plurality of memory locations accessed by a plurality of addresses. The write pointer may be configured to write data to the memory in response to a sequence of write addresses generated in response to a first control signal. The read pointer may be configured to read data from the memory in response to a sequence of read addresses generated in response to a second control signal. The control circuit may be configured to generate (i) the first control signal, and (ii) the second control signal. The order data is read from said memory may comprise a de-interleaved pattern with respect to the order the data is written to the memory.

### SUMMARY OF THE INVENTION

Embodiments of a de-interleaver constructed and operative according to the invention optionally accept input of interleaved blocks of data, and output de-interleaved blocks of data, using minimal memory.

According to an aspect of some embodiments of the present invention de-interleaving is performed “in-place”, such that data from a first super frame is output from a memory area into which a second, subsequent, super frame is being written at the same time. Proper care is taken, as described herein, that data from the first super frame is not overwritten before the data has been output from the de-interleaver. Bytes of incoming data are written into just-vacated locations of outgoing data. The order of reading/writing is dynamically calculated for each super frame, thereby ensuring that the outgoing data goes out in de-interleaved order.

According to an aspect of some embodiments of the present invention there is provided a de-interleaver for receiving data blocks including data units in an interleaved order, each data unit having a de-interleaved location within the data block, placing the data units in a memory buffer, and outputting the data units in a de-interleaved order from the memory buffer, the de-interleaver including an output unit configured to output a data unit from a location in the memory buffer of a next data unit in de-interleaved order, thereby to provide the data block in de-interleaved order, and an input unit configured with the output unit to input an incoming data unit, the incoming data unit being in the interleaved order, into the location in the memory buffer vacated by the next, in de-interleaved order, data unit being output.

According to some embodiments of the invention, the data unit being output is of a data block previous to the data block of the data unit being input.

According to some embodiments of the invention, further including a data and address controller configured to calculate the location in the memory buffer of the next, in de-interleaved order, data unit to be output. According to some embodiments of the invention, the data and address controller is configured to calculate when the input data unit, which replaces the data unit to be output, is received.

According to some embodiments of the invention, further including a second data and address controller, in which the second data and address controller is configured to calculate a location in the memory buffer into which the incoming data unit is to be placed.

According to some embodiments of the invention, a size of the memory buffer is equal to less than two blocks of data. According to some embodiments of the invention, a size of the memory buffer is equal to one block of data.

According to some embodiments of the invention, the interleaved block of data includes a super frame according to Integrated Services Digital Broadcasting for Satellite (ISDB-S).

According to some embodiments of the invention, further including a TMCC (Transmission and Multiplexing Configuration Control) decoder.

According to some embodiments of the invention, the data blocks include super frames, each of the super frames includes a plurality of frames, each of the frames includes a plurality of slots ordinally numbered, and the data is interleaved among same-numbered slots in different frames of the super frame.

According to some embodiments of the invention, the de-interleaver further includes an input configured to receive how many slots are included in a frame.

According to some embodiments of the invention, the data and address controller is configured to refer to locations in the memory buffer using a row pointer, which points to a beginning of a section in the memory buffer termed a virtual row, and a virtual index, which points to an offset from the beginning of the virtual row in the memory buffer.

According to some embodiments of the invention, each virtual row includes a number of bytes equal to a number of frames per super frame multiplied by a number of data units per slot.

According to some embodiments of the invention, the memory buffer includes a plurality of sub-memories and further including an address translator configured for translating the location of a next data unit in the memory buffer to a sub-memory address. According to some embodiments of the invention, the address translator includes a look up table for translating.

According to some embodiments of the invention, the de-interleaver further includes an input configured to receive a start of super frame synchronization signal. According to some embodiments of the invention, the de-interleaver further includes an input configured to receive a start of frame synchronization signal. According to some embodiments of the invention, the de-interleaver is configured to calculate start of super frame and start of frame locations based, at least partly, on a number of received data units and a number of slots per frame.

According to an aspect of some embodiments of the present invention there is provided a method for receiving data blocks including data units in an interleaved order, each data unit having a de-interleaved location within the data block, placing the data units in a memory buffer, and outputting the data units in a de-interleaved order from the memory buffer, the method including receiving the data block, and for each data unit of the data block calculating a location in the memory buffer of a next, in de-interleaved order, data unit of a previous data block, outputting the next, in de-interleaved order, data unit of the previous data block from the location in the memory buffer, thereby providing an output of the data unit of the previous data block in de-interleaved order, and inputting the data unit of the data block, in an order in which the data unit was received, to the location in the memory buffer.

According to some embodiments of the invention, the calculating is performed when the data unit of the data block is received.

According to some embodiments of the invention, further including calculating a location in the memory buffer into which the incoming data unit is to be placed.

According to some embodiments of the invention, a size of the memory buffer is equal to less than two blocks of data. According to some embodiments of the invention, a size of the memory buffer is equal to one block of data.

According to some embodiments of the invention, the interleaved block of data includes a super frame according to Integrated Services Digital Broadcasting for Satellite (ISDB-S).

According to some embodiments of the invention, further including receiving and decoding TMCC (Transmission and Multiplexing Configuration Control) data.

According to some embodiments of the invention, the data block includes a super frame, the super frame includes a plurality of frames, each of the frames includes a plurality of slots ordinally numbered, and the data is interleaved among same-numbered slots in different frames of the super frame.

According to some embodiments of the invention, further including receiving an input of how many slots are included in a frame. According to some embodiments of the invention, further including receiving a start of super frame synchronization signal. According to some embodiments of the invention, further including receiving a start of frame synchronization signal. According to some embodiments of the invention, further including calculating start of super frame and start of frame locations based, at least partly, on a number of received data units and a number of slots per frame.

According to some embodiments of the invention, locations in the memory buffer are referred to using a row pointer, which points to a beginning of a section in the memory buffer termed a virtual row, and a virtual index, which points to an offset from the beginning of the virtual row in the memory buffer. According to some embodiments of the invention, each virtual row includes a number of bytes equal to a number of frames per super frame multiplied by a number of data units per slot.

According to some embodiments of the invention, a counter is used for counting data units read from and written to a virtual row, the row pointer is used for determining from and to which virtual row the data units are input and output, the row pointer is incremented and the counter is initialized every N data units, N being equal to a number of data units per slot, the row pointer is incremented until equal to the number of slots per frame, after which the row pointer is reset. According to some embodiments of the invention, the row pointer is reset when a start of frame signal is received.

According to some embodiments of the invention, each data unit is input to and output from a location in the virtual row corresponding to the virtual index, calculated as follows

$${virt\_index}_{0} = 0 , \\ for i = 1 \text{:} virt\_row \_length - 1 , \\ tmp = {virt\_index}_{i - 1} + virt\_shift$$

$${virt\_index}_{i} = \{ \begin{matrix}tmp \% ( virt\_row \_length - 1 ) , & tmp \geq virt\_row \_length \\ tmp , & otherwise\end{matrix} \\ end for ;$$

where virt_indexᵢ is a virtual index for inputting and outputting a data unit, virt_index₀ is an initial value of the virtual index for a first data unit of a super frame, virt_row_length is equal to a number of data units in a virtual row, virt_indexᵢ₋₁ is a virtual index of an adjacent previous data unit, virt_shift is a variable used for shifting reading and writing indexes of data units in de-interleaved order, and tmp is a temporary variable.

According to some embodiments of the invention, the virtual index is calculated as follows

$${virt\_index}_{0} = 0 , \\ for i = 1 \text{:} virt\_row \_length - 1 , \\ tmp = {virt\_index}_{i - 1} + virt\_shift$$

$${virt\_index}_{i} = \{ \begin{matrix}tmp - virt\_row \_length + 1 , & tmp \geq virt\_row \_length \\ tmp , & otherwise\end{matrix} \\ end for ;$$

where virt_indexᵢ is a virtual index for inputting and outputting a data unit, virt_index₀ is an initial value of the virtual index for a first data unit of a super frame, virt_row_length is equal to a number of data units in a virtual row, virt_indexᵢ₋₁ is a virtual index of an adjacent previous data unit, virt_shift is a variable used for shifting reading and writing indexes of data units in de-interleaved order, and tmp is a temporary variable.

According to some embodiments of the invention, a first virtual index of a first one of the virtual rows is used as a first virtual index of subsequent virtual rows, and a next virtual index after the last virtual index of a last one of the virtual rows is used as the first virtual index of the first one of the virtual rows when the row pointer is reset. According to some embodiments of the invention, the virtual index is reset to zero at a beginning of a super frame.

According to some embodiments of the invention, the virt_shift is calculated for each super frame as follows

tmp=virt_shiftᵢ₋₁·virt_shift₀, virt_shift₀=n_frames virt_shiftᵢ=tmp %(virt_row_length−1)

where virt_shiftᵢ is a value of the virt_shift for a current super frame, virt_shiftᵢ₋₁ is a value of the virt_shift of an adjacent previous super frame, virt_shift₀ is an initial value of the virt_shift, and n_frames is a number of frames per super frame.

According to some embodiments of the invention, the virt_shift is calculated as follows

```
tmp = virt_shiftᵢ₋₁ · virt_shift₀, virt_shift₀ = n_frames
flag = 1
while(flag),
    tmp = virt_shift − virt_row_length + 1
    if (tmp ≧ 0),
        virt_shift = tmp
    else
        flag = 0
end
```

where virt_shiftᵢ is a value of the virt_shift for a current super frame, virt_shiftᵢ₋₁ is a value of the virt_shift of an adjacent previous super frame, virt_shift₀ is an initial value of the virt_shift, n_frames is a number of frames per super frame, and flag is another temporary variable.

According to some embodiments of the invention, a first virtual index of a first one of the virtual rows is used as a first virtual index of subsequent virtual rows, and a next virtual index after the last virtual index of a last one of the virtual rows is used as the first virtual index of the first one of the virtual rows when the row pointer is reset.

According to some embodiments of the invention, the virt_shift is calculated for each super frame as follows

tmp=virt_shiftᵢ₋₁·virt_shift₀, virt_shift₀=n_frames virt_shiftᵢ=tmp %(virt_row_length−1)

where virt_shiftᵢ is a value of the virt_shift for a current super frame, virt_shiftᵢ₋₁ is a value of the virt_shift of an adjacent previous super frame, virt_shift₀ is an initial value of the virt_shift, and n_frames is a number of frames per super frame.

According to some embodiments of the invention, the virt_shift is calculated as follows

```
tmp = virt_shiftᵢ₋₁ · virt_shift₀, virt_shift₀ = n_frames
flag = 1
while(flag),
    tmp = virt_shift − virt_row_length + 1
    if (tmp ≧ 0),
        virt_shift = tmp
    else
        flag = 0
end
```

where virt_shiftᵢ is a value of the virt_shift for a current super frame, virt_shiftᵢ₋₁ is a value of the virt_shift of an adjacent previous super frame, virt_shift₀ is an initial value of the virt_shift, n_frames is a number of frames per super frame, and flag is another temporary variable.

According to some embodiments of the invention, the memory buffer includes a plurality of sub-memories and further including translating the location in the memory buffer to a sub-memory address. According to some embodiments of the invention, the translating includes using a look up table.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory and/or a non-volatile storage, for example, a magnetic hard-disk, and/or flash memory, and/or removable media, for storing instructions and/or data. Optionally, a network connection is provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of the structure of an Integrated Services Digital Broadcasting for Satellite (ISDB-S) super frame, as is known in the art.

FIG. 2A is a simplified illustration of a method of interleaving data of eight same numbered slots of eight frames in a super frame according to the ISDB-S standard, as is known in the art.

FIG. 2B is a simplified illustration of interleaving in a super frame according to the ISDB-S standard, as is known in the art.

FIG. 3 is a simplified functional block diagram of a de-interleaver with two memory areas, each sufficient for a super frame.

FIG. 4A is a simplified functional block diagram of a de-interleaver constructed and operating according to an example embodiment of the present invention.

FIG. 4B is a more detailed simplified functional block diagram of an alternative embodiment of the de-interleaver of FIG. 4A.

FIG. 4C is a simplified block diagram of the memory of the de-interleaver of FIG. 4A.

FIG. 5 is a simplified flow chart illustration of a method of operation of the de-interleaver of FIG. 4A.

FIG. 6 is a simplified illustration of non-interleaved data in several same-numbered slots of several frames of one exemplary super frame.

FIG. 7 is a simplified illustration of the data of FIG. 6 in a non-interleaved order.

FIG. 8 is a simplified illustration of a virtual row containing the data of FIG. 6 from an initial super frame in an interleaved order.

FIG. 9 is a simplified illustration of the virtual row of FIG. 8 and an order in which the de-interleaver of FIG. 4A reads a first de-interleaved slot of data from the virtual row.

FIG. 10 is a simplified illustration of the virtual row of FIG. 8 and an order in which the de-interleaver of FIG. 4A reads a second de-interleaved slot of data from the virtual row.

FIGS. 11-13 are simplified illustrations of the virtual row of FIG. 8 and an order in which the de-interleaver of FIG. 4A reads a third, fourth and fifth de-interleaved slots of data from the virtual row.

FIG. 14 is a simplified illustration of the virtual row of FIG. 8 containing data from a second interleaved super frame in an order as written by the de-interleaver of FIG. 4A.

FIG. 15 is a simplified illustration of the virtual row of FIG. 14 and an order in which the de-interleaver of FIG. 4A reads a first de-interleaved slot of data from the virtual row.

FIG. 16 is a simplified illustration of the virtual row of FIG. 14 and locations of a second de-interleaved slot of data from the virtual row.

FIG. 17 is a simplified illustration of the virtual row of FIG. 14 containing data from a third super frame in an order as written by the de-interleaver of FIG. 4A.

FIG. 18 is a simplified functional block diagram of an alternative embodiment of the de-interleaver of FIG. 4A.

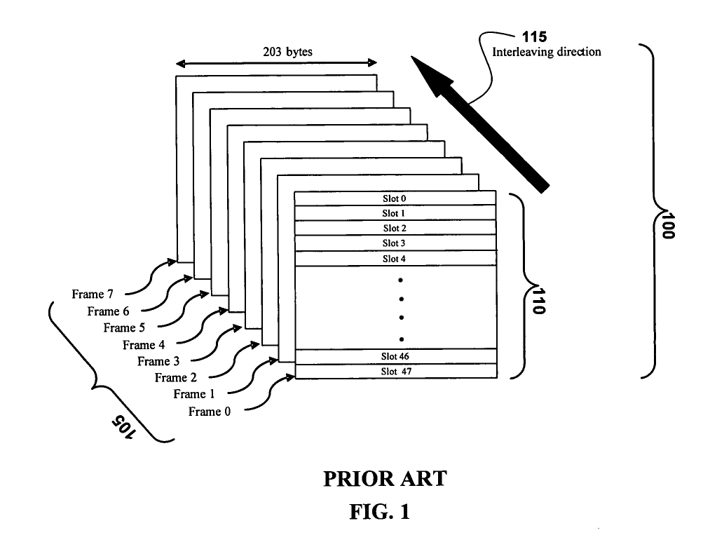

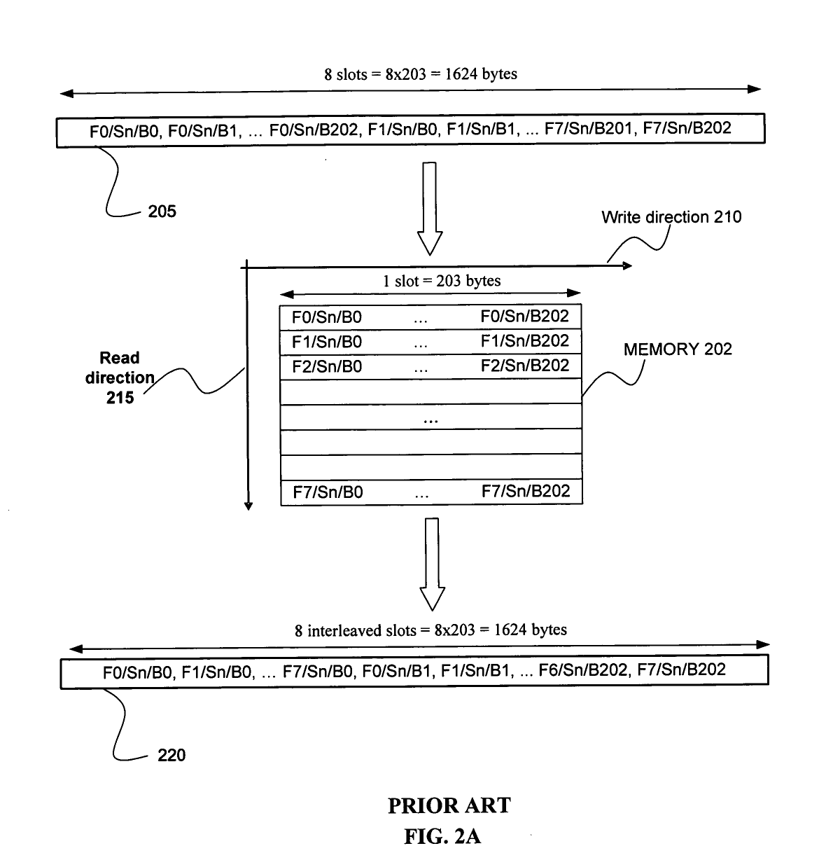

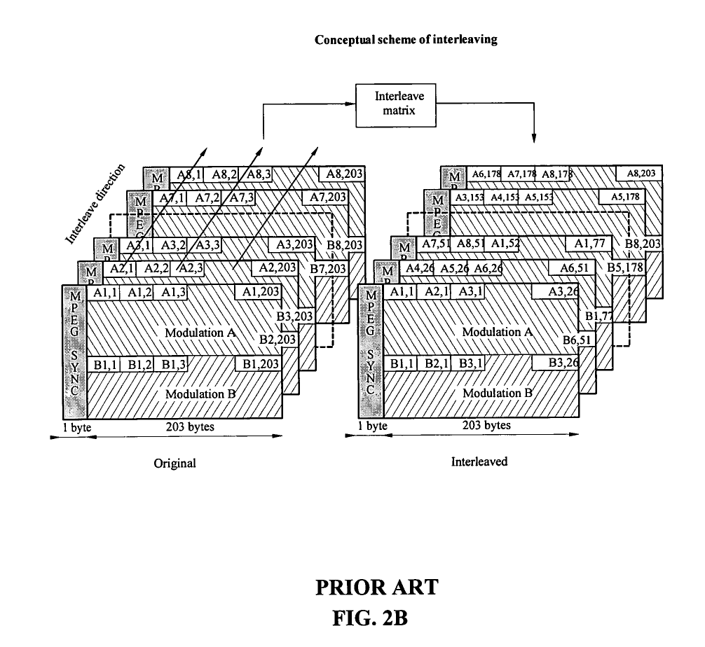

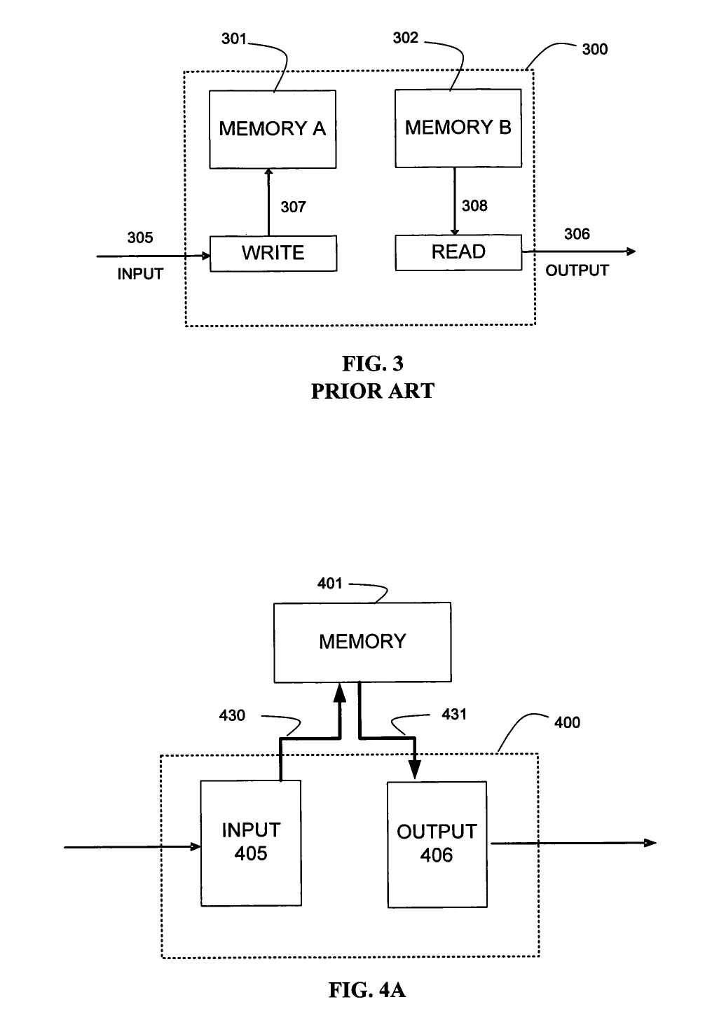

### DESCRIPTION OF SPECIFIC EMBODIMENTS OF THE INVENTION

The present invention, in some embodiments thereof, relates to an architecture of a de-interleaver and to a method of de-interleaving and, more particularly, but not exclusively, to an architecture of a de-interleaver and to a method for de-interleaving ISDB-S (Integrated Services Digital Broadcasting for Satellite) super frames.

An embodiment of the invention used as an example herein is a de-interleaver for a transport stream containing data according to the Japanese ISDB-S (Integrated Services Digital Broadcasting for Satellite) standard. The example is not intended to be limiting, but to provide one real world example. Persons skilled in the art can apply suitable changes to other data de-interleaving cases.

As used herein, the term “super frame” is used interchangeably with the term “block of data”. Most examples will be written using the term super frame, which is a term of the art in ISDB-S. Nevertheless, each time the term “super frame” is used the term “block of data” is also to be understood.

As used herein, the term “byte” means a data unit. Many systems use an 8-bit byte as a data unit, but the term byte, as used herein, refers to any other suitable data unit, such as a bit, a 4-bit nibble, a 16-bit word, a 32-bit word, and so on.

Building a de-interleaver component with an architecture which uses minimal memory results in cheaper systems. When the de-interleaver is built on a chip, the less memory used, the cheaper the chip. It is to be appreciated that in case of an ISDB-S de-interleaver, one block of memory sufficient for a maximum sized super frame is approximately 609 Kbits, and two blocks are approximately 1218 Kbits.

Some embodiments of the invention perform de-interleaving “in-place”, such that data from a first super frame is output from a memory area into which a second, subsequent, super frame is being simultaneously written. The embodiments of the invention ensure, as described herein, that data from the first super frame is not overwritten before the data has been output from the de-interleaver.

Such embodiments save memory of approximately one super frame, that is, approximately 609 Kbits. In other words, the embodiments save approximately 50% of the memory area used for storage of the super frame data, relative to a double buffer embodiment.

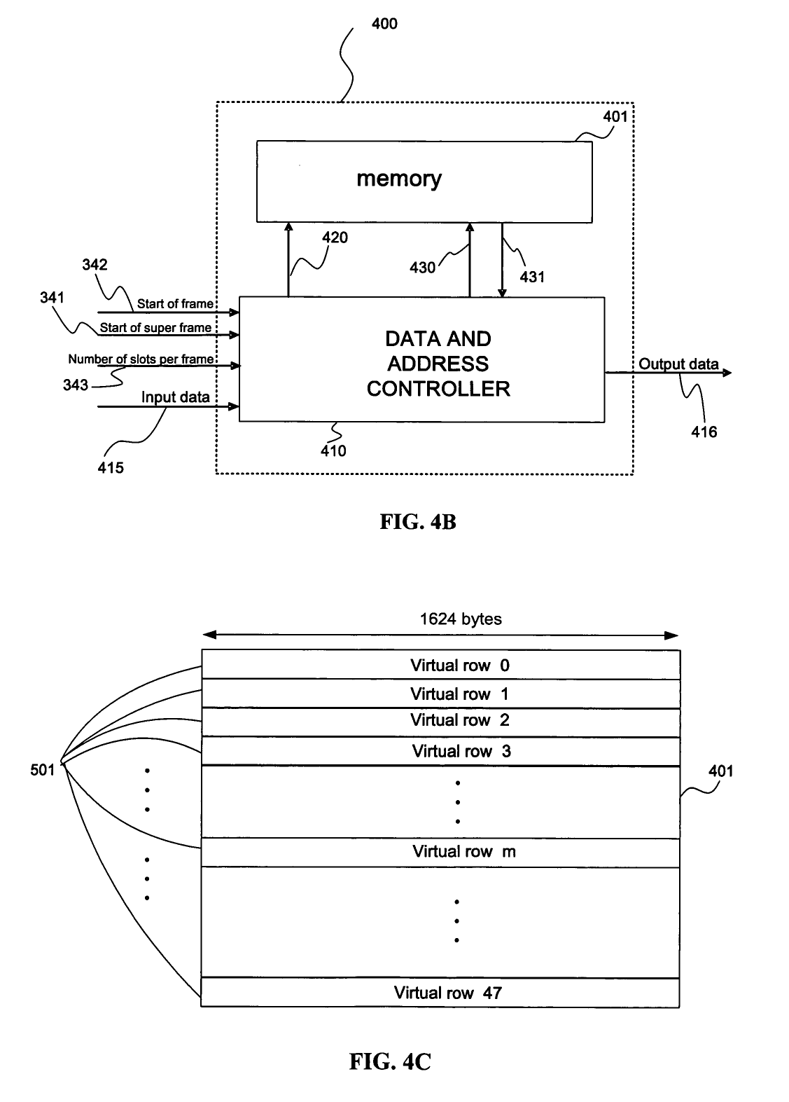

Reference is now made to FIG. 4A, which is a simplified functional block diagram of a de-interleaver 400 constructed and operating according to an example embodiment of the present invention.

The de-interleaver 400 includes an input unit 405, and an output unit 406. The de-interleaver 400 may include a memory 401 or the de-interleaver 400 may be operational to write data to and read data from the memory 401. In FIG. 4A the memory 401 is depicted as external to the de-interleaver 400, and the de-interleaver 400 is operational to write data to and read data from the memory 401.

The memory 401 comprises memory of a size sufficient to contain one maximum-sized super frame of data, which, in the exemplary case of ISDB-S, is 609 Kbits.

In some embodiments of the invention, the memory 401 is accessed by addressing virtual rows (not shown), described in more detail below with reference to FIG. 4C, and within each virtual row by specifying a virtual index, which is an offset from a beginning of the virtual row.

The de-interleaver 400 receives input of interleaved data of an ISDB-S super frame to the input unit 405, in an order in which the interleaved data exists in the super frame.

The de-interleaver 400 calculates a row pointer, pointing to one of the virtual rows, and a virtual index, pointing to a specific location within the virtual row. Together the row pointer and the virtual index define a location in the memory 401.

The de-interleaver 400 reads 431 output data, from the memory 401 at the location defined by the row pointer and the virtual index, to the output unit 406. The de-interleaver 400 output unit 406 outputs the output data.

The input unit 405 also writes 430 input data into the memory 401, at the location defined by the row pointer and the virtual index.

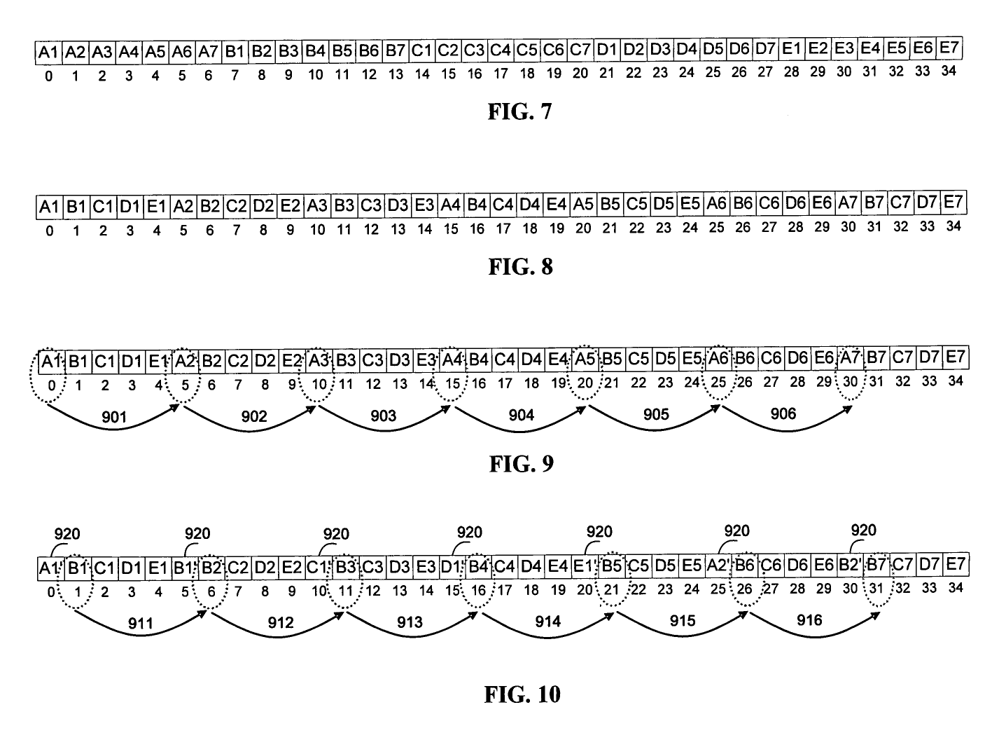

The order of reading data from the memory 401 corresponds to reading the super frame in order, one frame at a time, one slot at a time, and one byte at a time, such that the output data is de-interleaved. The reading is performed using the calculation of the memory locations for enabling in-place de-interleaving, using no more memory than required to contain one maximum sized super frame of data, as described further below with reference to FIGS. 7-17.

Reference is now made to FIG. 4B, which is a more detailed simplified functional block diagram of an alternative embodiment of the de-interleaver 400 of FIG. 4A.

The de-interleaver 400 comprises the memory 401 and a Data And Address Controller (DAAC) 410.

The DAAC 410 is configured to calculate read and write memory addresses needed for read and write operations.

The DAAC 410 comprises an interleaved data input 415 and a de-interleaved data output 416.

In some embodiments of the invention the DAAC 410 comprises an input indicating start of super frame 341; an input indicating start of frame 342. The DAAC 410 optionally also comprises an input indicating the number of slots per frame 343.

In some embodiments of the invention the DAAC 410 deciphers the above data from TMCC data received with the ISDB-S broadcast. The TMCC data is broadcast in advance of the super frame described by the TMCC data.

In some embodiments of the invention, the DAAC 410 produces a memory pointer 420, which is provided to the memory 401. The memory pointer 420 indicates at which address and a location within that address data is to be read out of the memory 401, being replaced with data which is written into the memory 401. The DAAC 410 writes 430 input data into the memory 401, at a location of the memory pointer 420, and reads 431 output data from the memory 401 from the location of the memory pointer 420. The DAAC 410 outputs the output data as the de-interleaved data output 416.

In some embodiments of the invention, the memory 401 contains one super frame of data. The de-interleaver 400 writes a byte of data from a current super frame, while at the same time reading a byte of data from a previous super frame, replacing one byte of data for every byte of data written. Since the size of a super frame is not fixed, the size of the memory 401 is equal to the maximum size which a super frame can have.

The ISDB-S super frame is constructed of 8 frames, each with a maximum of 48 slots of 203 bytes. The maximum size of one ISDB-S super frame is therefore:

1 super frame=8×48×203 bytes=77,952 bytes=623,616 bits

In an exemplary embodiment of the invention, the memory 401 comprises 48 virtual rows, each virtual row comprising 8×203=1624 bytes of data. The size of each virtual row is adapted to contain 8 slots of data, one slot from each one of 8 different frames. Virtual row #0 is adapted to contains slot #0 of frame #0, slot #0 of frame #1, and so on, up to slot #0 of frame #7. Virtual row #n is adapted to contain slot #n of frame #0, slot #n of frame #1, and so on, up to slot #n of frame #7.

Reference is now made to FIG. 4C, which is a simplified block diagram of the memory 401 of the de-interleaver of FIG. 4A. FIG. 4C depicts the memory 401 arranged in 48 virtual rows 501, each of which is 1624 bytes long. Each virtual row 501 contains data from one slot across all eight frames.

It is to be appreciated that the number of virtual rows containing data of a super frame corresponds to the number of slots in the super frame.

In order to read data from the memory 401 in de-interleaved order, the DAAC 410 first reads a first frame in the correct byte order and in order of slots 0 to 47 (or whatever the number of slots in the super frame actually is), then reads the second frame in the correct byte order and in order of slots 0 to 47, and so on. In order to read the correct byte order, the DAAC 410 waits until almost all the virtual rows have been written.

In order to enable writing a following super frame into memory, the DAAC 410 writes data into a location from which it is reading. Thus, the de-interleaver 400 reads and outputs de-interleaved data right before it writes input of interleaved data.

The DAAC 410 optionally directs bytes of the first slot of the first interleaved frame to virtual row #0 of the memory 401; bytes of the second slot of the first interleaved frame to virtual row #1 of the memory 401; and so on.

After input of the last slot of the first interleaved frame to the DAAC 410, which is optionally directed to virtual row #47, the DAAC 410 optionally directs a first slot of the second interleaved frame to virtual row #0 of the memory 401, the second slot of the second interleaved frame to virtual row #1 of the memory 401, and so on.

The DAAC 410 optionally keeps track of which virtual row is addressed for each slot by using an internal counter for counting arriving bytes. The DAAC 410 optionally increments a virtual row index after receiving 203 bytes, which is a full slot. The DAAC 410 optionally resets the virtual row index when reaching the number of slots per frame, or when receiving a start of frame signal.

In some embodiments of the invention the number of slots per frame is an external data signal such as the input 343 (FIG. 4B). In other embodiments of the invention the number of slots per frame is derived from decoded TMCC data. In still other embodiments of the invention, the number of slots per frame is computed using the start of frame input 342 (FIG. 4B) by resetting a virtual row index upon receiving a first byte of each frame.

In some embodiments of the invention the start of super frame input 341 is used for synchronization by resetting the internal byte counter and virtual row index with first byte of every super frame.

By tracking the current virtual row and writing data into the memory 401 accordingly, the de-interleaving process is separated into 48, or less, depending on the number of slots per frame, independent de-interleaving processes. At an end of writing the interleaved super frame to the memory 401, slot #0 of all interleaved frames is stored at virtual row #0 of the memory 401, slot #1 of all interleaved frames at virtual row #1, and so on.

After completing the writing of the first virtual row with data from the first slots of the interleaved frames, data output from the DAAC 410 is the first slot of the first de-interleaved frame.

Optionally, the DAAC 410 performs memory read and memory write operations for a full row at once. In such a case the memory pointer 420 comprises a memory address of a beginning of a virtual row, and a memory index, or offset, within the memory address, which indicates which byte is targeted for the read and/or write operation. Reading a byte, or a part of a row, is performed by reading a full row and masking the full row with a suitable mask which is calculated using the memory index. Writing part of a row is performed by using a suitable write mask in a write process.

Optionally, reading part of a row is performed by referring to specific bits of the read row in the reading process.

Optionally, when using a hardware register for reading from and writing to the memory 401, a full row is read into the register, a specific byte or bytes are replaced in the register, and the full row is written back into the memory 401.

Optionally, when using a software-based solution for reading from and writing to the memory 401, a full row is read into a variable, a specific byte or bytes are replaced in the variable, and the full row is written back into the memory 401.

Since the de-interleaving is performed on blocks of 8 same-numbered slots, one slot from each of 8 frames, stored on one virtual row, a description of a locating method will be given for one virtual row. The description is the same for all 48 virtual rows. An example of a method used by an embodiment of the invention when de-interleaving a plurality of different rows is provided below, after a detailed description of FIGS. 9-17.

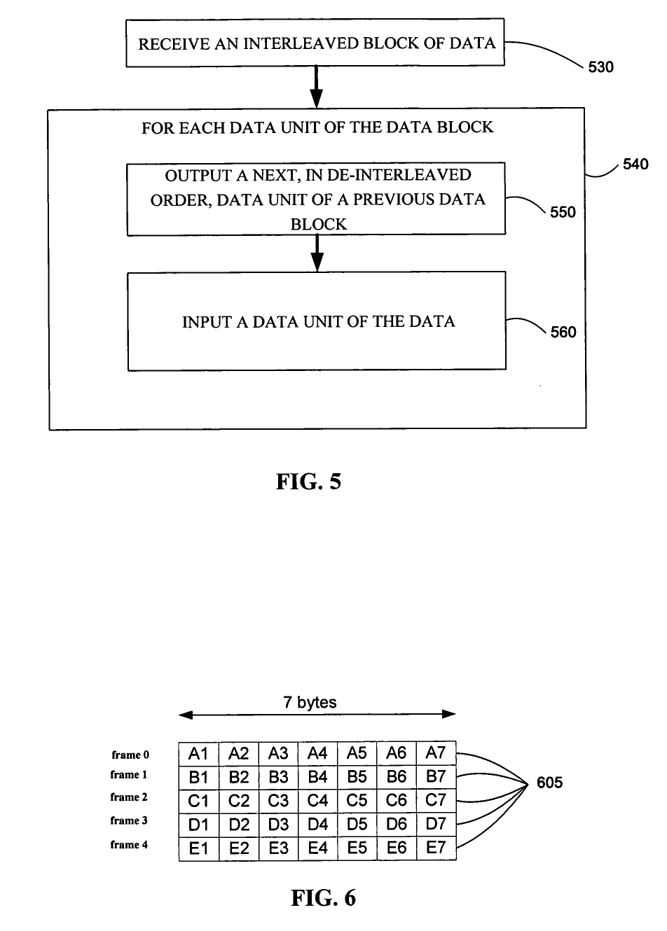

Reference is now made to FIG. 5, which is a simplified flow chart illustration of a method of operation of the de-interleaver of FIG. 4A.

An interleaved block of data, that is, an interleaved super frame, is received by the de-interleaver 400 (530).

In some embodiments of the invention, the de-interleaver 400 receives the interleaved super frame on-the-fly, that is, the de-interleaver 400 receives the interleaved super frame byte by byte, as the bytes are received by a receiver (not shown). In other embodiments the de-interleaver 400 receives the interleaved super frame after some delay.

The de-interleaver 400 starts reading incoming data from virtual row #0, in an order which will be further described below with reference to FIGS. 7-17.

For each data unit, or byte, of the incoming data block (540) the de-interleaver reads and outputs a byte of data from a previous super frame, in de-interleaved order (550); and replaces the output byte of data by inputting the incoming byte of data (560).

The above method guarantees that data is output in correct, de-interleaved order, and that data is input without overwriting data which had not been output yet in de-interleaved order.

Maintaining a correct order of reading and writing will be described in more detail below, with reference to FIGS. 7-17.

In order to simplify the description, a small amount of data is used as an example. The simplification does not reduce the generality of the method.

Reference is now made to FIG. 6, which is a simplified illustration of non-interleaved data in several same-numbered slots of several frames of one exemplary super frame.

The super frame (not shown) comprises 5 frames. Each frame comprises N slots 605 of 7 bytes each. The slot 605 from frame 0 comprises bytes A1, A2, A3, A4, A5, A6, and A7. The slots from frames 1-4 comprise bytes B1-B7, C1-C7, and so on up to E1-E7. The bytes are referred to according to the frame (A to E) they belong to, and according to their byte order (1 to 7). Note that the 7 byte references here are numbered 1-7, and the 5 frame references here are numbered 0-4.

The number of bytes in the 5 same-numbered slots of the 5 frames is 5×7=35.

Reference is now made to FIG. 7, which is a simplified illustration of the data of FIG. 6 in a non-interleaved order. The order of bytes in FIG. 7 is the order in which the bytes are input into an interleaver.

Reference is now made to FIG. 8, which is a simplified illustration of a virtual row containing the data of FIG. 6 from an initial super frame in an interleaved order. The order of bytes in FIG. 8 is the order in which the bytes are output from the interleaver, and also the order in which the bytes are input to the de-interleaver.

In some embodiments of the invention, the write order of the bytes of an initial interleaved super frame is sequential. The virtual row after the initial writing will appear as in FIG. 8.

It is to be appreciated that an initial writing of a first, initial, super frame typically happens without a corresponding output of meaningful data. The de-interleaver is expected to de-interleave a new data stream starting from the initial super frame on. Data existing in the memory prior to the writing of the initial block may be from a previously output data stream, but in any case the prior data is not treated as meaningful with respect to de-interleaving the new data stream.

At a next stage, that is, when a next super frame is input to the de-interleaver, before each new byte is written, a previous byte is output, in order to free the memory location for the new byte.

Thus, an order for writing a block of same-numbered slots from an interleaved second super frame into a virtual row is defined according to an output order of the already stored block. The output order results in a de-interleaved data sequence, that is: A1, A2, A3, A4, A5, A6, A7, B1, . . . , E5, E6, E7.

Reference is now made to FIG. 9, which is a simplified illustration of the virtual row of FIG. 8 and an order in which the de-interleaver of FIG. 4A reads a first de-interleaved slot of data from the virtual row. Bytes of data from a group of same-numbered slots from the first frame 605 (FIG. 6) are read in an order as described by the arrows 901 902 903 904 905 906. As can be seen, the reading picks up the bytes marked A1, A2, A3, A4, A5, A6, A7, in order. The ‘A’ bytes are located at virtual indexes, which are pointers in a virtual row, equal to 0, 5, 10, 15, 20, 25 and 30. The increment between following indexes is 5. The increment is termed virtual shift. The virtual index is defined by Equation 1 below:

virt_indexᵢ=virt_indexᵢ₋₁+virt_shift, virt_index₀=0 virt_shift=5 Equation 1

Reference is now made to FIG. 10, which is a simplified illustration of the virtual row of FIG. 8 and an order in which the de-interleaver of FIG. 4A reads a second de-interleaved slot of data from the virtual row. Bytes of data from the second frame 605 (FIG. 6) of a group of same-numbered slots are read in an order as described by the arrows 911 912 913 914 915 916. As can be seen, the reading picks up the bytes marked B1, B2, B3, B4, B5, B6, B7, in order. The ‘B’ bytes are located at virtual indexes, which are pointers in a virtual row, equal to 1, 6, 11, 16, 21, 26 and 31.

Equation 1 is therefore updated to be Equation 2, in order to define the virtual index past an end of the data of the first frame.

$${virt\_index}_{0} = 0 , \\ for i = 1 \text{:} virt\_row \_length - 1 , \\ tmp = {virt\_index}_{i - 1} + virt\_shift \\ {virt\_index}_{i} = \{ \begin{matrix}tmp \% ( virt\_row \_length - 1 ) , & tmp \geq virt\_row \_length \\ tmp , & otherwise\end{matrix} \\ end for ; \qquad Equation 2$$

virt_row_length in this example is 5×7=35.

The index list according to Equation 2 is: 0, 5, 10, 15, 20, 25, 30, 1, 6, 11, 16, 21, 26, 31, 2, 7, 12, 17, 22, 27, 32, 3, 8, 13, 18, 23, 28, 33, 4, 9, 14, 19, 24, 29 and 34, which complies with a de-interleaved order of the data.

In some embodiments of the invention, Equation 2 is replaced by Equation 3 below:

$${virt\_index}_{0} = 0 , \\ for i = 1 \text{:} virt\_row \_length - 1 , \\ tmp = {virt\_index}_{i - 1} + virt\_shift \\ {virt\_index}_{i} = \{ \begin{matrix}tmp - virt\_row \_length + 1 , & tmp \geq virt\_row \_length \\ tmp , & otherwise\end{matrix} \\ end for ; \qquad Equation 3$$

The modulus (%) operation in Equation 2 is replaced by subtraction and addition, which may be simpler to implement in some cases. Equation 3 holds true when the shift in the virtual index is not greater that the virtual row length.

It is to be appreciated that the seven ‘A’ bytes which were read from the virtual row have been replaced by seven data bytes from a second, subsequent super frame. Seven new bytes 920 (see FIG. 10) have been written into the virtual row in the order in which they were received by the de-interleaver, that is, in an interleaved order A1′, B1′, C1′ D1′, E1′, A2′ B2′.

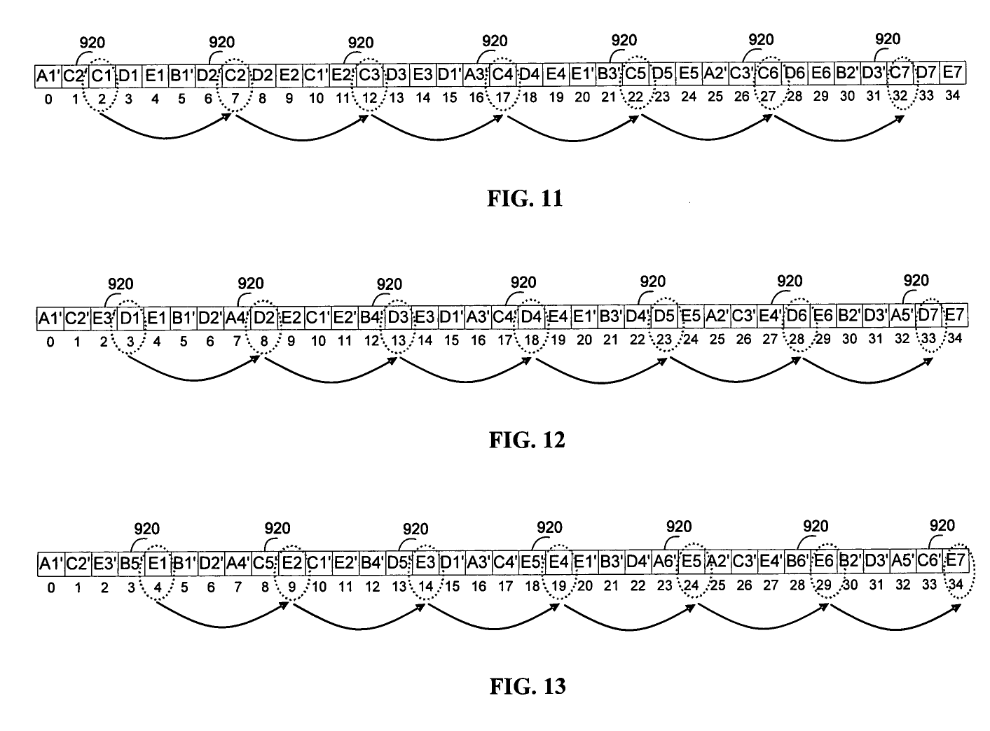

Reference is now made to FIGS. 11-13, which are simplified illustrations of the virtual row of FIG. 8 and an order in which the de-interleaver of FIG. 4A reads a third, fourth and fifth de-interleaved slots of data from the virtual row. The arrows in FIGS. 11-13 show the order of reading the data of the third, fourth, and fifth frames from the group of same-numbered slots comprised in a virtual row.

It is to be appreciated that in FIGS. 11-13 the ‘B’, ‘C’, and ‘D’ bytes which were read from the virtual row have been replaced by suitable data bytes from a second, subsequent super frame. Each one of the depictions of FIGS. 11-13 depicts replaced data bytes from the replacement described by the previous drawing. New bytes 920 (see FIGS. 11-13) have been written into the virtual row in the order in which they were received by the de-interleaver, that is, in an interleaved order. The new bytes are marked with an apostrophe, that is A1′-A7′, B1′-B7′, C1′-C7′, and D1′-D7′.

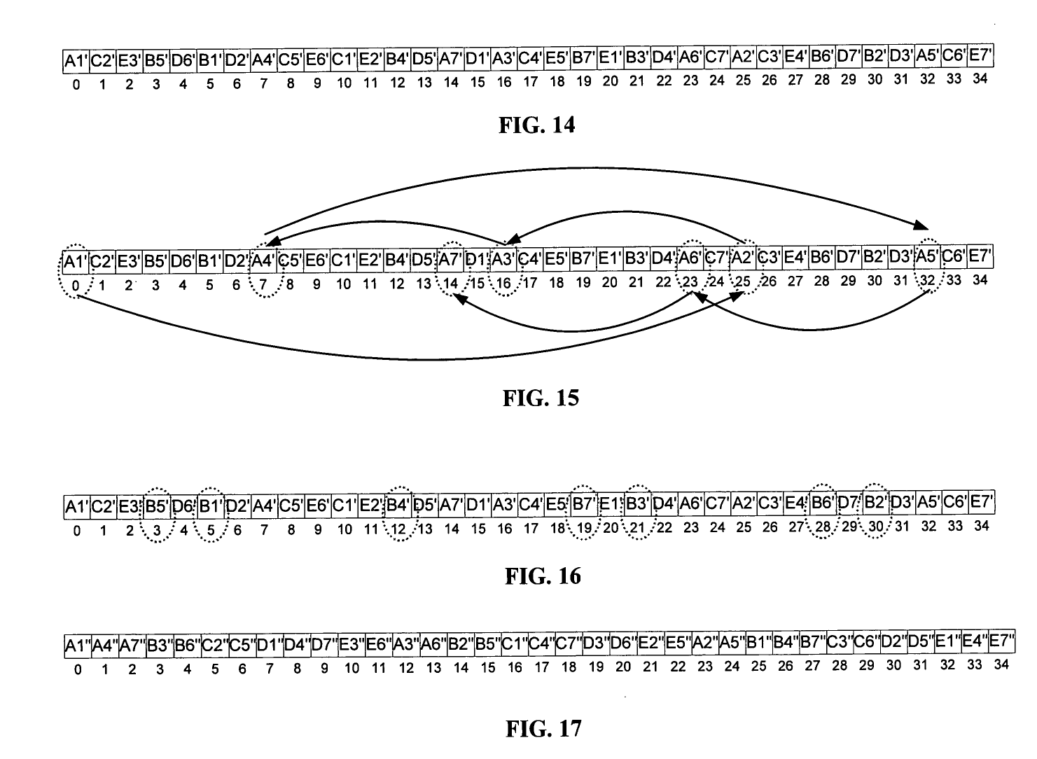

Reference is now made to FIG. 14, which is a simplified illustration of the virtual row of FIG. 8 containing data from a second interleaved super frame in an order as written by the de-interleaver of FIG. 4A.

After reading a first initial super frame of interleaved data out of the de-interleaver, and writing at the same memory locations a second subsequent interleaved super frame of data into the de-interleaver, the data of the group of same-numbered slots appears as depicted in FIG. 14.

It is noted that before de-interleaving an additional super frame, virt_index is reset to virt_index=0.

Reference is now made to FIG. 15, which is a simplified illustration of the virtual row of FIG. 14 and an order in which the de-interleaver of FIG. 4A reads a first de-interleaved slot of data from the virtual row.

In order to de-interleave data from the second super frame, the first seven bytes which need to be read are A1′, A2′, A3′, A4′, A5′, A6′, and A7′. Indexes of the bytes are 0, 25, 16, 7, 32, 23, and 14. The indexes are not in the order calculated by Equation 2 or Equation 3 using virtual_shift=5.

Reference is now made to FIG. 16, which is a simplified illustration of the virtual row of FIG. 14 and locations of a second de-interleaved slot of data from the virtual row. FIG. 16 shows the next data bytes to be read, at locations 5, 30, 21, 12, 3, 28 and 19.

In order to keep using the above introduced equations for the indexes, the DAAC 410 computes virtual_shift of a current super frame based on the virtual_shift of a previous super frame. The new virtual_shift is computed according to Equation 4 below:

virt_shiftᵢ=virt_shift_{—}virt_shift₀, virt_shift₀=n_frames Equation 4

where n_frames is the number of frames per super frame.

In the current example, n_frames=5. For the second super frame, the new virtual_shift is 5×5=25. Using Equations 2 or 3 to calculate the indexes for the second super frame, the following indexes are computed: 0, 25, 16, 7, 32, 23, 14, 5, 30, 21, 12, 3, 28, 19, 10, 1, 26, 17, 8, 33, 24, 15, 6, 31, 22, 13, 4, 29, 20, 11, 2, 27, 18, 9, and 34.

Reference is now made to FIG. 17, which is a simplified illustration of the virtual row of FIG. 14 containing data from a third super frame in an order as written by the de-interleaver of FIG. 4A.

After outputting the data of the second super frame from the memory 401 in the index order above, and replacing data from the next, third, interleaved super frame to the memory 401 in the same order, the data from the third super frame is placed in the virtual row in an order depicted in FIG. 17.

According to the Equation 4, the next virtual_shift, for the third super frame, should be 25·5=125. A virtual_shift of 125 contradicts the constraint that virtual_shift is not greater than the virtual row length. Since Equations 2 and 3 force index wrap-around, the following correction is applied to Equation 4, producing Equation 5 below.

tmp=virt_shiftᵢ₋₁ virt_shift₀, virt_shift₀=n_frames virt_shifts=tmp %(virt_row_length−1)

In the example above, the virtual_shift for the third super frame according to Equation 4 is 125% 34=23. Applying the virtual_shift to Equation 5 results in the following virtual indexes: 0, 23, 12, 1, 24, 13, 2, 25, 14, 3, 26, 15, 4, 27, 16, 5, 28, 17, 6, 29, 18, 7, 30, 19, 8, 31, 20, 9, 32, 21, 10, 33, 22, 11 and 34. The indexes of data in de-interleaved order in FIG. 17, marked as bytes A1″-A7″, B1″-B7″, C1″-C7″, D1″-D7″, and E1″-E7″, show that the order of the above indexes is correct.

An equation corresponding to Equation 5 without the modulus operation is also possible, in form of Equation 6 below:

$$tmp = {virt\_shift}_{i - 1} \cdot {virt\_shift}_{0} , \\ {virt\_shift}_{0} = n\_frames \\ flag = 1 \\ while ( flag ) , \\ tmp = virt\_shift - virt\_row \_length + 1 \\ if ( tmp \geq 0 ) , \\ virt\_shift = tmp \\ else \\ flag = 0 \\ end \qquad Equation 6$$

In the example above, calculating virtual indexes for each super frame and calculating virtual shifts and resetting virt_index between consecutive super frames, produces a full de-interleaving mechanism. After 16 computations of virtual_shift in the given example of 7×5 bytes per super frame slot, the next virtual_shift will equal 5, that is, equal virt_shift₀. In other words, the virtual shifts have a periodicity of 16.

For the ISDB-S de-interleaver each block length is 203×8=1624 bytes, and virt_shift₀ equals 8. The periodicity of the virtual_shift of the ISDB-S super frame equals 180.

It is to be appreciated that virt_shift₀ does not have to start as equal to n_frames. virt_shift₀ may be set at a beginning of de-interleaving a stream of super frames to any of the values which virtual_shift acquires during its periodic progress.

While de-interleaving an ISDB-S super frame, the de-interleaver 400 receives input of an interleaved super frame in order: slots of a first interleaved frame first, then slots of a second interleaved frame, and so on. As a result, after writing the first 203 bytes, that is the first slot, of the first interleaved frame in suitable order in the first virtual row, the next data entering the de-interleaver 400 is from a second slot of the first interleaved frame, which is written to the second virtual row. The DAAC 410 directs the first 203 incoming bytes to the first virtual row, the next 203 incoming bytes to the second virtual row, and so on, until a 48^{th} group of 203 bytes are directed to the 48^{th} virtual row. The next 203 bytes, which comprise bytes from the first slot of the second frame, are directed back to the first virtual row, and so on.

To perform as described above, in some embodiments of the invention, the DAAC 410 keeps track of the virtual index while transferring from one virtual row to the next and when jumping back from the last virtual row back to the first virtual row. Keeping track is optionally done by saving a first virtual index used at a beginning of the first virtual row, using the saved virtual index at the beginning of all the next virtual rows. Furthermore, a next computed virtual index after the last used virtual index of the last virtual row is optionally used as a first virtual index of the first virtual row when returning to the first virtual row. By keeping track like this, the interleaving of each virtual row stays independent of each other.

In some embodiments of the invention, detecting a last virtual row of each frame is done by counting slots, which may be done, for example, by counting multiples of 203 bytes, until reaching the number of slots per frame of the current super frame.

The number of slots per frame of the current super frame may be programmed, or alternatively may be known by deciphering TMCC data of a previous super frame.

In other embodiments of the invention, detecting a last virtual row of each frame is performed by the de-interleaver reading a start of frame signal.

In some embodiments of the invention, if a present super frame contains a different number of slots than a previous super frame, the de-interleaver 400 does not compensate for the change, causing data from one super frame to be lost. That is a simple and practical solution to such a situation because: changing the number of slots per super frame is very rare, so that such super frames would be lost very rarely; and because ISDB-S data typically carries digital television, so a rare loss of an image with an immediate return to television reception is typically not a problem.

In other embodiments of the invention, the de-interleaver 400 does compensate for a change of the number of slots per super frame. The de-interleaver 400 uses two sets of counters (not shown) for tracking units of data, one set for reading data, one set for writing data. Reading data from the memory 401 (FIGS. 4A, 4B, 4C) proceeds at a maximal rate appropriate for ISDB-S. This ensures that memory locations are available for incoming data, since the memory locations are vacated at a rate equal to or greater than data is incoming.

At start of reception of the super frames, the read set of counters and the write set of counters start by pointing at the same memory locations for reading and writing. After that, the read set of counters and the write set of counters each track the read memory locations and the write memory locations respectively, and may not point to the same memory locations.

When a change of the number of slots per super frame occurs, the read set of counters, which is used for reading a super frame received before the change, performs calculations using the number of slots per super frame according to the number of slots per super frame in the super frame received before the change, and the write set of counters, which is used for writing a super frame received after the change, performs calculations using the number of slots per super frame according to the number of slots per super frame in the super frame, received after the change, or by using the start of frame signal for returning back to the first virtual row.

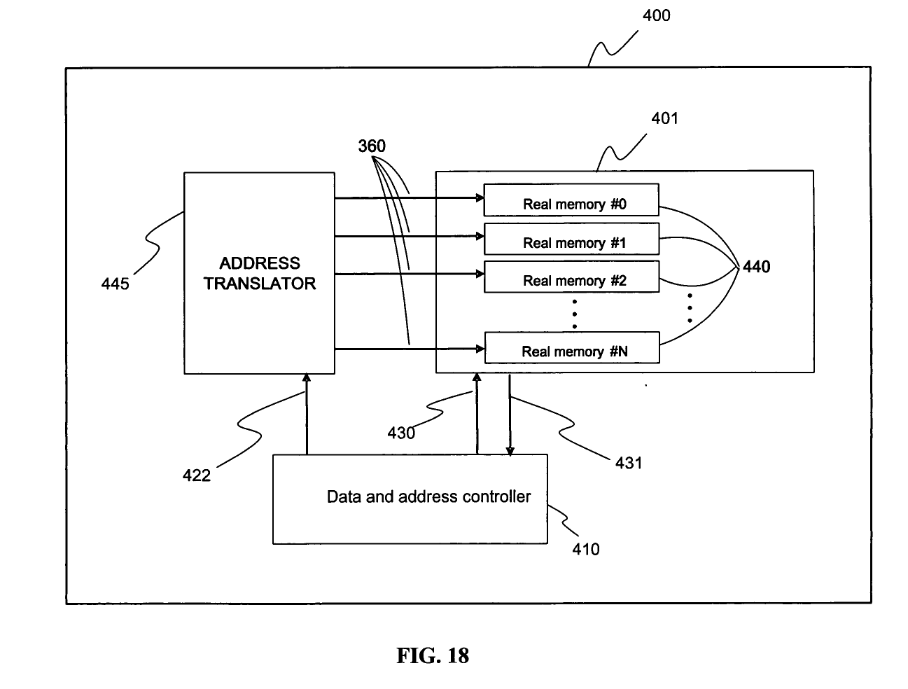

In some embodiments of the invention, the de-interleaver 400 comprises two units of DAAC 410 (FIGS. 4B, 18), one DAAC 410 for the read set of counters and one DAAC 410 for the write set of counters.

Reference is now made to FIG. 18, which is a simplified functional block diagram of an alternative embodiment of the de-interleaver of FIG. 4A.

Some embodiments of the invention use more than one block of physical memory, comprising together the memory 401 (FIGS. 4A and 4B). The memory 401 is composed of several sub memories 440, and the de-interleaver 400 optionally uses an address translator (AT) 445. Each of the sub memories may contain equal amounts of memory, or different amounts of memory. A sub-memory may contain more than a virtual row's worth of memory, may contain exactly a virtual row's worth, or may contain less than a virtual row's worth.

The AT 445 receives inputs 422 of virtual row pointers and virtual indexes from the DAAC 410 and translates the inputs 422 into physical memory pointers 360, pointing to physical addresses. The physical memory pointer 360 addresses a suitable one of the sub memories 440 in the memory 401, and within the suitable sub memory 440, a specific memory location.

The DAAC 410 provides data 430 for writing into the memory 401, at a location of the physical memory pointer 360, and receives from the memory 401 data 431 from the location of the physical memory pointer 360.

In some embodiments of the invention the AT 445 optionally performs the translation using a look up table, and in some embodiments the AT 445 optionally performs the translation by calculating the translation in real time. In yet other embodiments the AT 445 optionally performs the translation using a combination of a look up table and of real time calculation.

Choosing which of the above embodiments to implement may be done according to the number of the smaller memories 440 and the sizes of the smaller memories 440.

A look up table takes up memory. When the smaller memories are all or most of a same size, or when there is a small number of smaller memories, it is possible to calculate a translation without using a look up table, and save memory taken up by the look up table.

While the invention has been particularly shown and described with reference to the preferred embodiments thereof, it will be understood by those skilled in the art that various changes in form and details may be made without departing from the spirit and scope of the invention.

It is expected that during the life of a patent maturing from this application many relevant interleaving standards will be developed and the scope of the term de-interleaving is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A de-interleaver for receiving data blocks comprising data units in an interleaved order, each data unit having a de-interleaved location within the data block, placing said data units in a memory buffer, and outputting said data units in a de-interleaved order from said memory buffer, the de-interleaver comprising:
an output unit configured to output a data unit from a location in the memory buffer of a next data unit in de-interleaved order, thereby to provide the data block in de-interleaved order; and
an input unit configured with the output unit to input an incoming data unit, said incoming data unit being in said interleaved order, into the location in the memory buffer vacated by said next, in de-interleaved order, data unit being output.

2. The de-interleaver of claim 1, in which the data unit being output is of a data block previous to the data block of the data unit being input.

3. The de-interleaver of claim 1 and further comprising a data and address controller configured to calculate the location in the memory buffer of said next, in de-interleaved order, data unit to be output.

4. The de-interleaver of claim 3 in which the data and address controller is configured to calculate when the input data unit, which replaces the data unit to be output, is received.

5. The de-interleaver of claim 3 and further comprising a second data and address controller, in which the second data and address controller is configured to calculate a location in the memory buffer into which the incoming data unit is to be placed.

6. The de-interleaver of claim 1 in which a size of the memory buffer is equal to less than two blocks of data.

7. The de-interleaver of claim 1 in which a size of the memory buffer is equal to one block of data.

8. The de-interleaver of claim 1 in which the interleaved block of data comprises a super frame according to Integrated Services Digital Broadcasting for Satellite (ISDB-S).

9. The de-interleaver of claim 8 and further comprising a TMCC (Transmission and Multiplexing Configuration Control) decoder.

10. The de-interleaver of claim 1 in which the data blocks comprise super frames, each of the super frames comprises a plurality of frames, each of the frames comprises a plurality of slots ordinally numbered, and the data is interleaved among same-numbered slots in different frames of the super frame.

11. The de-interleaver of claim 10 in which the de-interleaver further comprises an input configured to receive how many slots are comprised in a frame.

12. The de-interleaver of claim 10 in which the data and address controller is configured to refer to locations in the memory buffer using:
a row pointer, which points to a beginning of a section in the memory buffer termed a virtual row; and
a virtual index, which points to an offset from the beginning of the virtual row in the memory buffer.

13. The de-interleaver of claim 12 in which each virtual row comprises a number of bytes equal to a number of frames per super frame multiplied by a number of data units per slot.

14. The de-interleaver of claim 1 in which the memory buffer comprises a plurality of sub-memories and further comprising an address translator configured for translating the location of a next data unit in the memory buffer to a sub-memory address.

15. The de-interleaver of claim 14 in which the address translator comprises a look up table for translating.

16. The de-interleaver of claim 10 in which the de-interleaver further comprises an input configured to receive a start of super frame synchronization signal.

17. The de-interleaver of claim 10 in which the de-interleaver further comprises an input configured to receive a start of frame synchronization signal.

18. The de-interleaver of claim 10 in which the de-interleaver is configured to calculate start of super frame and start of frame locations based, at least partly, on a number of received data units and a number of slots per frame.

19. A method for receiving data blocks comprising data units in an interleaved order, each data unit having a de-interleaved location within the data block, placing said data units in a memory buffer, and outputting said data units in a de-interleaved order from said memory buffer, the method comprising:
receiving the data block; and
for each data unit of the data block:
calculating a location in the memory buffer of a next, in de-interleaved order, data unit of a previous data block;
outputting said next, in de-interleaved order, data unit of the previous data block from the location in the memory buffer, thereby providing an output of the data unit of the previous data block in de-interleaved order; and
inputting the data unit of the data block, in an order in which the data unit was received, to the location in the memory buffer.

20. The method of claim 19 in which the calculating is performed when the data unit of the data block is received.

21. The method of claim 19 and further comprising calculating a location in the memory buffer into which the incoming data unit is to be placed.

22. The method of claim 19 in which a size of the memory buffer is equal to less than two blocks of data.

23. The method of claim 19 in which a size of the memory buffer is equal to one block of data.

24. The method of claim 19 in which the interleaved block of data comprises a super frame according to Integrated Services Digital Broadcasting for Satellite (ISDB-S).

25. The method of claim 24 and further comprising receiving and decoding TMCC (Transmission and Multiplexing Configuration Control) data.

26. The method of claim 19 in which the data block comprises a super frame, the super frame comprises a plurality of frames, each of the frames comprises a plurality of slots ordinally numbered, and the data is interleaved among same-numbered slots in different frames of the super frame.

27. The method of claim 26 and further comprising receiving an input of how many slots are comprised in a frame.

28. The method of claim 26 and further comprising receiving a start of super frame synchronization signal.

29. The method of claim 26 and further comprising receiving a start of frame synchronization signal.

30. The method of claim 26 and further comprising calculating start of super frame and start of frame locations based, at least partly, on a number of received data units and a number of slots per frame.

31. The method of claim 26 in which locations in the memory buffer are referred to using:
a row pointer, which points to a beginning of a section in the memory buffer termed a virtual row; and
a virtual index, which points to an offset from the beginning of the virtual row in the memory buffer.

32. The method of claim 31 in which each virtual row comprises a number of bytes equal to a number of frames per super frame multiplied by a number of data units per slot.

33. The method of claim 31 in which:
a counter is used for counting data units read from and written to a virtual row;
the row pointer is used for determining from and to which virtual row the data units are input and output;
the row pointer is incremented and the counter is initialized every N data units, N being equal to a number of data units per slot;
the row pointer is incremented until equal to the number of slots per frame, after which the row pointer is reset.

34. The method of claim 33 in which the row pointer is reset when a start of frame signal is received.

35. The method of claim 33 in which each data unit is input to and output from a location in the virtual row corresponding to the virtual index, calculated as follows:
$${virt\_index}_{0} = 0 , \\ for i = 1 \text{:} virt\_row \_length - 1 , \\ tmp = {virt\_index}_{i - 1} + virt\_shift \\ {virt\_index}_{i} = \{ \begin{matrix}tmp \% ( virt\_row \_length - 1 ) , & tmp \geq virt\_row \_length \\ tmp , & otherwise\end{matrix} \\ end for ; \qquad$$
where:
virt_indexᵢ is a virtual index for inputting and outputting a data unit;
virt_index₀ is an initial value of the virtual index for a first data unit of a super frame;
virt_row_length is equal to a number of data units in a virtual row;
virt_indexᵢ₋₁ is a virtual index of an adjacent previous data unit;
virt_shift is a variable used for shifting reading and writing indexes of data units in de-interleaved order; and
tmp is a temporary variable.

36. The method of claim 33 in which the virtual index is calculated as follows:
$${virt\_index}_{0} = 0 , \\ for i = 1 \text{:} virt\_row \_length - 1 , \\ tmp = {virt\_index}_{i - 1} + virt\_shift$$
$${virt\_index}_{i} = \{ \begin{matrix}tmp - virt\_row \_length + 1 , & tmp \geq virt\_row \_length \\ tmp , & otherwise\end{matrix} \\ end for ;$$
where:
virt_indexᵢ is a virtual index for inputting and outputting a data unit;
virt_index₀ is an initial value of the virtual index for a first data unit of a super frame;
virt_row_length is equal to a number of data units in a virtual row;
virt_indexᵢ₋₁ is a virtual index of an adjacent previous data unit;
virt_shift is a variable used for shifting reading and writing indexes of data units in de-interleaved order; and
tmp is a temporary variable.

37. The method of claim 35 in which:
a first virtual index of a first one of the virtual rows is used as a first virtual index of subsequent virtual rows; and
a next virtual index after the last virtual index of a last one of the virtual rows is used as the first virtual index of the first one of the virtual rows when the row pointer is reset.

38. The method of claim 35 in which the virtual index is reset to zero at a beginning of a super frame.

39. The method of claim 37 in which the virt_shift is calculated for each super frame as follows:
tmp=virt_shiftᵢ₋₁·virt_shift₀, virt_shift₀=n_frames virt_shiftᵢ=tmp %(virt_row_length−1)
where:
virt_shiftᵢ is a value of the virt_shift for a current super frame;
virt_shiftᵢ₋₁ is a value of the virt_shift of an adjacent previous super frame;
virt_shift₀ is an initial value of the virt_shift; and
n_frames is a number of frames per super frame.

40. The method of claim 39 in which the virt_shift is calculated as follows:
```
tmp = virt_shiftᵢ₋₁ · virt_shift₀, virt_shift₀ = n_frames
flag = 1
while(flag),
    tmp = virt_shift − virt_row_length + 1
    if (tmp ≧ 0),
        virt_shift = tmp
    else
        flag = 0
end
```
where:
virt_shiftᵢ is a value of the virt_shift for a current super frame;
virt_shiftᵢ₋₁ is a value of the virt_shift of an adjacent previous super frame;
virt_shift₀ is an initial value of the virt_shift;
n_frames is a number of frames per super frame; and
flag is another temporary variable.

41. The method of claim 36 in which:
a first virtual index of a first one of the virtual rows is used as a first virtual index of subsequent virtual rows; and
a next virtual index after the last virtual index of a last one of the virtual rows is used as the first virtual index of the first one of the virtual rows when the row pointer is reset.

42. The method of claim 41 in which the virt_shift is calculated for each super frame as follows:
tmp=virt_shiftᵢ₋₁·virt_shift₀, virt_shift₀=n_frames virt_shiftᵢ=tmp %(virt_row_length−1)
where:
virt_shiftᵢ is a value of the virt_shift for a current super frame;
virt_shiftᵢ₋₁ is a value of the virt_shift of an adjacent previous super frame;
virt_shift₀ is an initial value of the virt_shift; and
n_frames is a number of frames per super frame.

43. The method of claim 42 in which the virt_shift is calculated as follows:
```
tmp = virt_shiftᵢ₋₁ · virt_shift₀, virt_shift₀ = n_{—} frames
flag = 1
while(flag),
    tmp = virt_shift − virt_row_length + 1
    if (tmp ≧ 0),
        virt_shift = tmp
    else
        flag = 0
end
```
where:
virt_shiftᵢ is a value of the virt_shift for a current super frame;
virt_shiftᵢ₋₁ is a value of the virt_shift of an adjacent previous super frame;
virt_shift₀ is an initial value of the virt_shift;
n_frames is a number of frames per super frame; and
flag is another temporary variable.

44. The method of claim 19 in which the memory buffer comprises a plurality of sub-memories and further comprising translating the location in the memory buffer to a sub-memory address.

45. The method of claim 44 in which the translating comprises using a look up table.
